(19) United States
(12) Patent Application Publication
(10) Pub. No.: US 2015/0046724 A1
(43) Pub. Date: Feb. 12, 2015

(54) POWER SUPPLY METHODS AND ELECTRONIC DEVICES

(71) Applicant: Lenovo (Beijing) Limited, Beijing (CN)

(72) Inventor: Yanfei Xu, Beijing (CN)

(73) Assignee: Lenovo (Beijing) Limited, Beijing (CN)

(21) Appl. No.: 14/228,451

(22) Filed: Mar. 28, 2014

(30) Foreign Application Priority Data
Aug. 8, 2013 (CN) 201310344538.X

(51) Int. Cl. G06F 1/26

(52) U.S. Cl. CPC G06F 1/26; G06F 2200/261
USPC 713/300

(57) ABSTRACT

The present disclosure discloses a power supply method and an electronic device, the method is applied to the electronic device, the electronic device comprises M interfaces, and M is an integer which is larger than or equal to 2. The method comprises: obtaining power supply orders corresponding to the M interfaces, when the electronic device being switched from a non-operating state to an operating state; and supplying power to N devices connected to the M interfaces in the power supply orders, wherein N is an integer which is larger than or equal to 1 and less than or equal to M.

### TECHNICAL FIELD

The present disclosure relates to electronic technology fields, and more particularly, to power supply methods and electronic devices.

### BACKGROUND

With development of sciences and technologies, the electronic technologies have been developed rapidly, a growing number types of electronic devices have emerged, and the people has been enjoyed a various conveniences brought by the development of sciences and technologies. Nowadays, the people may enjoy a comfortable life brought by the development of sciences and technologies through various types of electronic devices. For example, the electronic devices such as a notebook computer, a desktop computer have been became an important portion of the people's life. A user may use the electronic device such as a notebook computer, a desktop computer to enjoy music, play games etc. to alleviate the press brought by the rapid modem life.

At present, the electronic devices such as a notebook computer, a desktop computer can be connected to the other devices such as a camera, a scanner, a movable hard disk through a universal serial bus interface (USB interface) in order to extend functions thereof, thereby enabling the functions of the electronic device such as a notebook computer, a desktop computer to become richer.

However, the inventor finds that the above technologies at least have the following technical problems in implementing the technical scheme of the embodiments of the present disclosure:

In case of the electronic devices such as a notebook computer, a desktop computer being connected to a plurality of devices through the universal serial bus interface, the large amount of current can be supplied to the plurality of connected devices when the electronic device such as a notebook computer, a desktop computer is switched from a non-operating state to an operating state, thereby resulting in the electronic device power off or the connected electronic device out of use.

Particularly, taking the notebook computer as an example, the notebook computer is connected to the camera, the scanner, the plurality of hard disks etc. through the universal serial bus interface or the other interfaces; and the power supply of the notebook computer further supplies power to the connected device while it supplies power to the means such as main board, graphic card inside the notebook computer, when the notebook computer is switched from the non-operating state to the operating state, for example from S5/S4/S3 states to S0 state. Since the current supplied by the power supply of the notebook computer for an instant is constant, the total current required by the means inside the notebook computer and the connected devices for an instant exceeds a maximum current which can be supplied by the power supply for an instant, this will cause the power supplied to the means inside the notebook computer or the connected devices insufficient, thereby resulting in the electronic device power off or the connected device out of use.

Thus, there is a following technical problem: the power supplied to the means inside the electronic device and the connected devices will insufficient, when the electronic device is connected to a plurality of devices through the universal serial bus interface, thereby resulting in the electronic device power off or the connected device out of use.

### SUMMARY

Embodiments of the present disclosure provide power supply methods and electronic devices, and address the technical problem: the power supplied to the means inside the electronic device and the connected devices will insufficient, when the electronic device such as a notebook computer, a desktop computer is connected to a plurality of devices through the universal serial bus interface, thereby resulting in the electronic device power off or the connected device out of use.

An embodiment of the present disclosure provides a power supply method which is applied to an electronic device, wherein the electronic device comprises M interfaces, and M is an integer which is larger than or equal to 2, the method comprises: obtaining power supply orders corresponding to the M interfaces, when the electronic device being switched from a non-operating state to an operating state; and supplying power to N devices connected to the M interfaces in the power supply orders, wherein N is an integer which is larger than or equal to 1 and less than or equal to M.

Optionally, supplying power to the N devices connected to the M interfaces in the power supply orders particularly comprises: supplying power to the N devices at a first interval in the power supply orders.

Optionally, the first interval is particularly 10-100 ms.

Optionally, the types of the M interfaces at least comprise a universal serial bus interface.

A further embodiment of the present disclosure provides an electronic device, comprising: a housing; a power supply disposed within the housing; a circuit board disposed within the housing and connected to the power supply; M interfaces disposed on the circuit board and connected to the power supply, wherein M is an integer which is larger than or equal to 2; and a processor disposed on the circuit board and adapted to obtain power supply orders corresponding to the M interfaces, when the electronic device being switched from a non-operating state to an operating state, and to supply power to N devices connected to the M interfaces in the power supply orders, wherein N is an integer which is larger than or equal to 1 and less than or equal to M.

Optionally, the processor particularly is adapted to supplying power to the N electronic devices at a first interval in the power supply orders.

Optionally, the first interval is particularly 10-100 ms.

Optionally, the types of the M interfaces at least comprise a universal serial bus interface.

One or more technical schemes provided by embodiments of the present disclosure have the following technical effects or advantages:

1. The power supply orders corresponding to the M interfaces are obtained when the electronic device is switched from the non-operating state to the operating state, and the power is supplied to the N devices connected to the M interfaces in the power supply orders, that is to say, the electronic device does not supply power to the N devices connected to the M interfaces simultaneously, instead of supplying power to the N devices in the power supply orders corresponding to the M interfaces, when the electronic device is switched from the non-operating state to the operating state, thereby reducing the current intensity required by the means inside the electronic device and the connected devices for an instant, i.e. the requirement of the instantaneous power supply capability of the power supply of the electronic device. Thus, the following technical problem in the related art may be addressed: the power supplied to the means inside the electronic device and the connected devices will insufficient, when the electronic device such as a notebook computer, a desktop computer is connected to a plurality of devices through the universal serial bus interface, thereby resulting in the electronic device power off or the connected device out of use. Accordingly, the technical effect of improving the stability of the electronic device may be implemented.

### BRIEF DESCRIPTION OF THE DRAWINGS

FIG. 1 is a flow chart of a power supply method according to an embodiment of the present disclosure; and

FIG. 2 is a schematic block diagram of an electronic device according to an embodiment of the present disclosure.

### DETAILED DESCRIPTION OF THE EMBODIMENTS

Embodiments of the present disclosure address the following technical problem in the related art by providing a power supply method and a electronic device: the power supplied to the means inside a electronic device and the connected devices will insufficient, when the electronic device such as a notebook computer, a desktop computer is connected to a plurality of devices through the universal serial bus interface, thereby resulting in the electronic device power off or the connected device out of use.

The technical scheme in embodiments of the present disclosure has the following general concept in order to address the above technical problem:

An embodiment of the present disclosure provides a power supply method which is applied to an electronic device such as a notebook computer, or a desktop computer, the electronic device comprises M interfaces, wherein M is an integer which is larger than or equal to 2, the method comprises: firstly, obtaining power supply orders corresponding to the M interfaces, when the electronic device being switched from a non-operating state to an operating state, for example from S5/S4/S3 state into S0 state; and then supplying power to N devices connected to the M interfaces in the power supply orders, wherein N is an integer which is larger than or equal to 1 and less than or equal to M.

As can be seen from the above, the power supply orders corresponding to the M interfaces are obtained when the electronic device is switched from the non-operating state to the operating state. And the power is supplied to the N devices connected to the M interfaces in the power supply orders, that is to say, the electronic device does not supply power to the N devices connected to the M interfaces simultaneously, instead of supplying power to the N devices in the power supply orders corresponding to the M interfaces, when the electronic device is switched from the non-operating state to the operating state. This thereby reduces the current intensity required by the means inside the electronic device and the connected devices for an instant, i.e. the requirement of the instantaneous power supply capability of the power supply of the electronic device. Thus, the f technical problem may be addressed. Accordingly, the technical effect of improving the stability of the electronic device may be implemented.

In the following, the above technical scheme of the present disclosure will be further explained with reference to the figures and particular embodiments, for a better understanding the above technical scheme of the present disclosure.

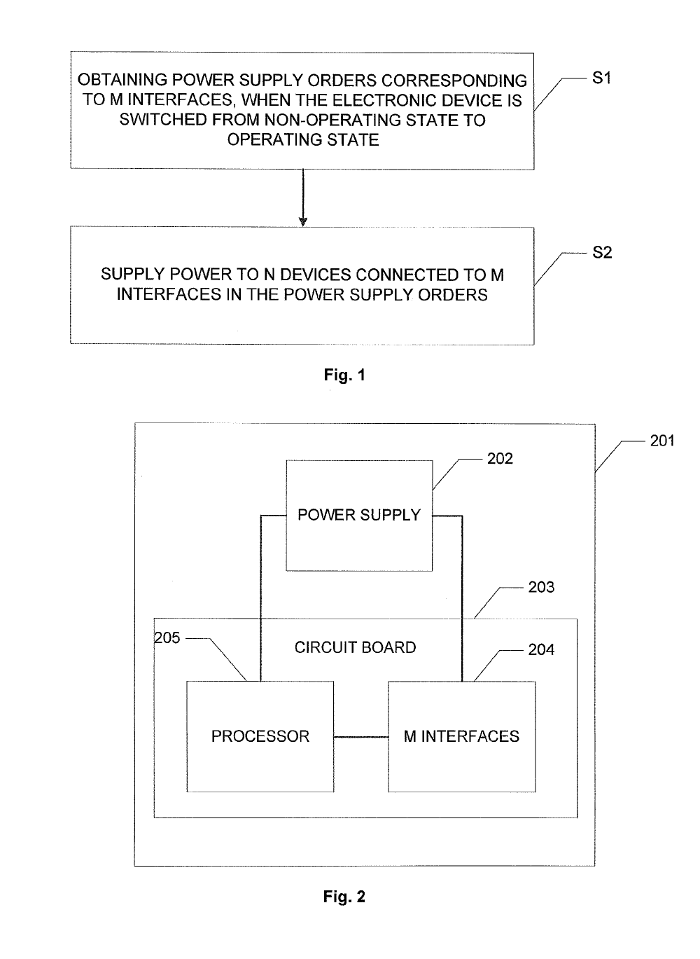

Referring to FIG. 1, a flow chart of a power supply method provide by an embodiment of the present disclosure is shown. The electronic device includes M interfaces, wherein M is an integer which is larger than or equal to 2. In practical application, the electronic device according to the embodiment of the present disclosure may be a notebook computer, or a desktop computer, but is not limited to this. In the following, the power supply method of the notebook computer taken as an example will be illustrated in detail.

As shown in FIG. 1, the power supply method provided by the embodiment of the present disclosure includes: S1, obtaining power supply orders corresponding to the M interfaces, when the electronic device being switched from a non-operating state to an operating state; and S2, supplying power to N devices connected to the M interfaces in the power supply orders, wherein N is an integer which is larger than or equal to 1 and less than or equal to M.

In a practical application, the notebook computer includes a plurality of interfaces, such as a universal serial bus interface, a PS/2 interface etc., all of these interfaces can provide an operating current to the connected devices such as a scanner, a camera, a movable hard disk etc., thereby supporting the normal operation of these connected device.

Firstly, before step S1, that is, before obtaining the power supply orders corresponding to the M interfaces when the notebook computer is switched from the non-operating state to the operating state, the method provided by the embodiment of the present disclosure further includes: setting the power supply orders corresponding to the M interfaces, and storing the power supply orders in a storage unit.

For example, the notebook computer includes 8 universal serial bus interfaces and 2 PS/2 interfaces, the power supply orders of the two PS/2 interfaces can be set to the first and the second respectively, and the power supply orders of the universal serial bus interfaces can be set to the third, the fourth, . . . , the tenth, and then the power supply orders corresponding to the 10 interfaces are stored in a storage unit such as a BIOS chip or a specific storage chip (but not limited to this).

Setting the power supply orders corresponding to the M interfaces can be done by the manufacturer after the manufacturing of the notebook computer is completed, and also can be done by the user himself through the corresponding software or system application, but is not limited to this.

Certainly, it is noted that the universal serial bus interfaces and the PS/2 interfaces are only intended for illustration of the technical scheme in the embodiment of the present disclosure, but are not intended to limit the disclosure. By introducing this embodiment, one skilled in the art can add the other required interfaces into the power supply orders to satisfy the requirement of the actual case, the repeat description of it is not made.

In a particular implementation, in addition to setting the power supply orders of the M interfaces in advance, the notebook computer may generate the power supply orders of the M interfaces randomly when the notebook computer is switched from the non-operating state to the operating state, such that the electronic device can supply power in these power supply orders. Of course, by introducing this embodiment, one skilled in the art can select the other suitable ways to set the power supply orders according to the actual case, the repeat description of it is not made.

In step S1, the power supply orders corresponding to the M interfaces are obtained when the electronic device is switched from the non-operating state to the operating state. Particularly, the notebook computer may acquire the power supply orders corresponding to the M interfaces stored by the above way from the BIOS chip or the specific storage chip, or acquire the power supply orders of the M interfaces which are generated by the notebook computer randomly, thereby enabling the electronic device to supply power to the N devices connected to the M interfaces in this power supply orders.

The method provided by the embodiment of the present disclosure proceeds to the step S2 after obtaining the power supply orders corresponding to the M interfaces obtained by the step S1, at step S2, the power is supplied to the N devices connected to the M interfaces in the power supply orders, wherein N is an integer which is larger than or equal to 1 and less than or equal to M.

Particularly, the power is supplied to the N devices connected to the M interfaces at a first interval.

For example, as mentioned above, the notebook computer includes 8 universal serial bus interfaces and 2 PS/2 interfaces, and an interface having a first order is connected with a movable hard disk, an interface having a second order is connected with a scanner, an interface having a fifth order is connected with a camera, and an interface having a sixth order is connected with a USB disk, and the interfaces having the other orders are idle. The power supply method provided by the embodiment of the present disclosure can control the notebook computer to supply power in the power supply orders, so as to supply power to 4 devices connected to 10 interfaces at the first interval, i.e. supply power to the movable disk, the scanner, the camera, and the USB disk sequentially at the first interval after obtaining the power supply orders corresponding to the 10 interfaces of the notebook computer by the step S1, thereby enabling the power supply of the notebook computer not to supply power to the means inside the notebook computer and the connected devices for an instant simultaneously, instead of supplying power the means inside the notebook computer and the connected devices in the power supply orders sequentially. Thus, the current intensity required by the means inside the electronic device and the connected devices for an instant, i.e. the requirement of the instantaneous power supply capability of the power supply of the notebook computer can be reduced. Thus, the following technical problem in the related art may be addressed: the power supplied to the means inside the electronic device and the connected devices will insufficient, when the electronic device such as a notebook computer, a desktop computer is connected to a plurality of electronic devices through the universal serial bus interface, thereby resulting in the electronic device power off or the connected device out of use. Accordingly, the technical effect of improving the stability of the electronic device may be implemented.

In a practical application, a corresponding switch circuit may be set for each of the M interfaces, such that the notebook computer can supply power to the connected device through the interfaces according to the corresponding switch circuits. Also, one switch circuit may be set, such that the notebook computer may control to supply power to the device connected to each of the M interfaces through the switch circuit. Of course, by introducing this embodiment, one skilled in the art can select the other suitable ways to set the power supply orders according to the actual case, the repeat description of it is not made.

In a particular implementation, in order to not affect the normal use of the device connected to the notebook computer, the first interval cannot be set to be too short, too short first interval may not be used to reduce the requirement of the instantaneous power supply capability of the power supply; at the same time, the first interval cannot be set to be too long, too long first interval may affect the normal use of the devices connected to the notebook computer. For example, the last connected device will be used after 18 s elapsed from the notebook computer being switched from the non-operating state to the operating state when it is enabled, if the notebook computer is connected to 10 devices, and the first interval is set as 2 s, this obviously increases the waiting time of the user, thereby reducing the user experiments of the notebook computer.

In order to avoid the above two cases, the first interval may be set as a value between 10 ms and 100 ms, so as to not obviously increase the waiting time of the user to avoid extravagance of time while effectively reducing the requirement of the instantaneous power supply capability of the power supply of the notebook computer.

Based on the same concept of the disclosure, an embodiment of the present disclosure also provides an electronic device. Referring to FIG. 1, a schematic block diagram of an electronic device according to an embodiment of the present disclosure is shown. As shown in FIG. 2, the electronic device includes: a housing 201; a power supply 202 disposed within the housing 201; a circuit board 203 disposed within the housing and connected to the power supply 202; M interfaces 204 disposed on the circuit board 203 and connected to the power supply 202, wherein M is an integer which is larger than or equal to 2; a processor 205 disposed on the circuit board 203.

In a particular implementation, the processor 205 is adapted to supplying power to the N electronic devices at a first interval in power supply orders.

In a particular implementation, the first interval is particularly 10-100 ms.

In a particular implementation, the electronic device also includes a storage unit disposed within the housing and connected to the processor 205 and adapted to store the power supply orders.

In a particularly implementation, the types of the M interfaces at least include a universal serial bus interface.

The electronic device in this embodiment and the power supply method in the above embodiment are based on the following two aspects of the same inventive concept. Since the implementation of the method has been described in detail in the above description, one skilled in the art can clearly understand the structure and implementation of the electronic device in this embodiment according to the above description. For simple purpose, repeat description of it is not made.

The above technical schemes in embodiments of the present disclosure have the following technical effects or advantages:

The power supply orders corresponding to the M interfaces are obtained when the electronic device is switched from the non-operating state to the operating state, and the power is supplied to the N devices connected to the M interfaces in the power supply orders, that is to say, the electronic device does not supply power to the N devices connected to the M interfaces simultaneously, instead of supplying power to the N devices in the power supply orders corresponding to the M interfaces, when the electronic device is switched from the non-operating state to the operating state, thereby reducing the current intensity required by the means inside the electronic device and the connected devices for an instant, i.e. the requirement of the instantaneous power supply capability of the power supply of the electronic device. Thus, the following technical problem in the related art may be addressed: the power supplied to the means inside the electronic device and the connected devices will insufficient, when the electronic device such as a notebook computer, a desktop computer is connected to a plurality of devices through the universal serial bus interface, thereby resulting in the electronic device power off or the connected device out of use. Accordingly, the technical effect of improving the stability of the electronic device may be implemented.

It should be appreciated that the embodiments of the present disclosure may be provided as methods, systems, or computer programs. Therefore, the present disclosure may be implemented in hardware, software, or combination thereof. Further, the present disclosure may be implemented as a computer program product embodied on one or more computer-readable storage media (including but not limited to disk storage device, CD-ROM, optical storage device, etc.) having computer-readable program codes therein.

The present disclosure is described with reference to flow charts and/or block diagrams of the methods, devices (systems), and computer program products. It is to be understood that any flow and/or block in the flow charts and/or block diagrams and any combination of flow and/or block in the flow charts and/or block diagrams may be implemented by computer program instructions. These computer program instructions may be provided to processors of general purpose computers, special purpose computers, embedded processors or any other programmable data processing devices to form a machine such that means having functions specified in one or more flows in the flow charts and/or one or more blocks in the block diagrams can be implemented by instructions executed by processors of the computers or any other programmable data processing devices.

The computer program instructions may also be stored in computer readable memories which may guide the computers or any other programmable data processing devices to function in such a manner that the instructions stored in these computer readable memories may generate manufactures including instruction means, the instruction means implementing functions specified in one or more flows in the flow charts and/or one or more blocks in the block diagrams.

These computer program instruction may also loaded to computers or any other programmable data processing devices such that a series of operation steps are performed on the computers or any other programmable devices to generate processing implemented by the computers. Therefore, the instructions executed on the computers or any other programmable devices provide steps for implementing functions specified in one or more flows in the flow charts and/or one or more blocks in the block diagrams.

It is obvious that one skilled in the art may make various modifications and variants to the present disclosure without departing from the spirit and scope of the present disclosure. In this way, if these modifications and variants of the present disclosure belong to the scope of the claims of the present disclosure and its full scope equivalents, the present disclosure is intended to embrace these modifications and variants.

What is claimed is:

1. A power supply method which is applied to an electronic device, wherein the electronic device comprises M interfaces, and M is an integer which is larger than or equal to 2, the method comprises:
obtaining power supply orders corresponding to the M interfaces, when the electronic device being switched from a non-operating state to an operating state; and
supplying power to N devices connected to the M interfaces in the power supply orders, wherein N is an integer which is larger than or equal to 1 and less than or equal to M.

2. The method of claim 1, wherein supplying power to the N devices connected to the M interfaces in the power supply orders particularly comprises:
supplying power to the N devices at a first interval in the power supply orders.

3. The method of claim 2, wherein the first interval is particularly 10-100 ms.

4. The method of claim 1, wherein the electronic device further comprises a storage unit, the method further comprises before obtaining the power supply orders corresponding to the M interfaces:
setting the power supply orders, and storing the power supply orders in the storage unit.

5. The method of claim 1, wherein the types of the M interfaces at least comprise a universal serial bus interface.

6. An electronic device, comprising:
a housing;
a power supply disposed within the housing;
a circuit board disposed within the housing and connected to the power supply;
M interfaces disposed on the circuit board and connected to the power supply, wherein M is an integer which is larger than or equal to 2; and
a processor disposed on the circuit board and adapted to obtain power supply orders corresponding to the M interfaces, when the electronic device being switched from a non-operating state to an operating state, and to supply power to N electronic devices connected to the M interfaces in the power supply orders, wherein N is an integer which is larger than or equal to 1 and less than or equal to M.

7. The electronic device of claim 6, wherein the processor particularly is adapted to supplying power to the N electronic devices at a first interval in the power supply orders.

8. The electronic device of claim 7, wherein the first interval is particularly 10-100 ms.

9. The electronic device of claim 6, wherein the electronic device further comprises a storage unit disposed within the housing and connected to the processor, and the storage unit is adapted to store the power supply orders.

10. The electronic device of claim 6, wherein the types of the M interfaces at least comprise a universal serial bus interface.
